(19) United States
(12) Patent Application Publication
(10) Pub. No.: US 2010/0015350 A1
(43) Pub. Date: Jan. 21, 2010

(54) PROCESS OF PRODUCING AN ABRADABLE THERMAL BARRIER COATING WITH SOLID LUBRICANT

(75) Inventor: David B. Allen, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS POWER GENERATION, INC., Orlando, FL (US)

(21) Appl. No.: 12/174,219

(22) Filed: Jul. 16, 2008

(51) Int. Cl. B05D 1/32

(52) U.S. Cl. 427/448

(57) ABSTRACT

A process (20) of producing an abradable thermal barrier coating (38) with a uniformly distributed solid lubricant (46) such as for gas turbine shroud ring segments. A mixture of a ceramic precursor powder (23) and a solid lubricant precursor powder in a liquid (22) is injected (28) into a thermal jet (32), such as one generated by a plasma gun (30). The precursor powders (23, 24) are dissolved or suspended in the liquid, forming a uniform spray mix (34) that is atomized in the thermal jet (32). The resulting spray mix (34) is directed toward a substrate (36), producing layers (39a-39c) of overlapping adherent ceramic splats (42) surrounded generally uniformly by an amount of solid lubricant (46) sufficient to increase abradability of the layers to a given degree, and thus protect turbine blade tips from damage during adjacent rotation with zero clearance.

### FIELD OF THE INVENTION

The invention relates to abradable thermal barrier coatings (TBCs) for high temperature gas turbine components, and particularly to TBCs for shroud ring segments.

### BACKGROUND OF THE INVENTION

Abradable coatings are used for controlling the clearance between the rotating blades and the stationary ring segments (blade outer working gas seals) in gas turbine engines. In the hot turbine section, these coatings are made of ceramic oxide materials such as yttria-stabilized zirconia (YSZ) or other similar compositions. These ceramic materials are much harder than the metal of the blades, and when the blades rub against the ceramic coatings, the blades are worn preferentially. It is desirable that the ceramic coating be worn instead of the blade, so several strategies have been devised to increase the abradability (ability to be rubbed away) of the ceramic coating. One such strategy is the incorporation of a multitude of pores in the coating, which decreases its density, and thus increases abradability. Another strategy is to spray the coating in such a way that the inherent coating density is low.

A further strategy is to mix the ceramic precursor powder with a solid lubricant powder prior to application by means such as plasma spray, resulting in the entrapment of some of the solid lubricant in the final coating. However, in current practice the solid lubricant tends to form large, unevenly distributed blobs inside the coating structure. Despite this poor distribution, solid lubricants such as hexagonal boron nitride (h-BN) are often used in such coatings. While h-BN provides lubrication similarly to graphite, it works at higher temperatures.

### BRIEF DESCRIPTION OF THE DRAWINGS

The invention is explained in the following description in view of the drawings that show:

FIG. 1 illustrates a system and process of producing an abradable thermal barrier coating by solution precursor plasma spray with included solid lubricant.

FIG. 2 is a schematic sectional view illustrating the process of coating layer build-up.

FIG. 3 is a sectional view of a coating system resulting from the process of FIGS. 1 and 2.

FIG. 4 shows a gradient application of the lubricant phase starting from a low proportion at the substrate to a higher proportion at an upper level of the coating.

### DETAILED DESCRIPTION OF THE INVENTION

The present inventor has recognized that a solution precursor plasma spray (SSPS) process is uniquely beneficial for the application of an abradable thermal barrier coating. In abradable thermal barrier coatings the inventor desires for solid lubricant particles to be distributed generally uniformly in the areas of contact between adjacent “splats” (flattened disks of ceramic formed by the impact of the molten particle on the substrate during plasma spray application), thus reducing intersplat adhesion, and increasing coating abradability. The invention herein circumvents the limitations of conventional spraying of ceramic and solid lubricant mixtures by incorporating the solid lubricant into a liquid feedstock solution. Herein, the term “solution” includes solutions and/or suspensions of materials in a liquid.

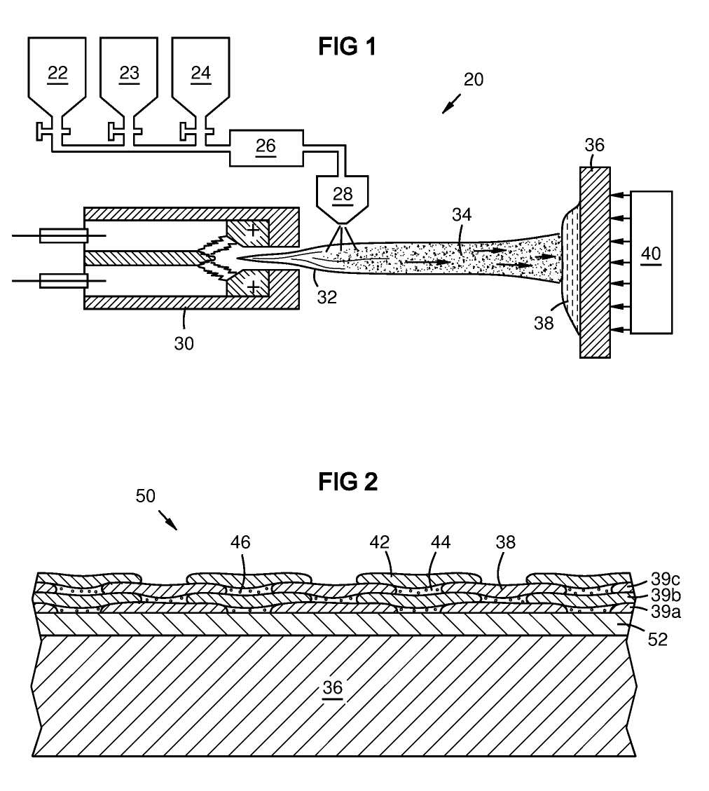

FIG. 1 illustrates a system and process 20 for producing an abradable ceramic thermal barrier coating 38 on a substrate 36 by mixing a liquid 22, a ceramic precursor powder 23, and a solid lubricant precursor powder 24 to form a solution and/or suspension. For example, the liquid may be water, the ceramic precursor materials may include yttria and zirconia, and the solid lubricant precursor materials may include boron trichloride and urea, guanidine, melamine, or other organic nitrogen compounds. A pump 26 routes the solution to an atomizing nozzle 28 that injects the solution into a thermal jet 32. A plasma gun 30 may be used to produce the thermal jet 32. The jet further atomizes and melts the precursors. In the heat of the plasma flame 32 the precursors react chemically to form desired final compounds such as yttria-stabilized zirconia and h-BN. Aluminum-containing organo-metallic compounds may also be injected to increase the aluminum content of the h-BN, thus increasing its stability in an oxygen-containing atmosphere to increase its service temperature capability. The temperature of the substrate 36 may be controlled during the spray process by a temperature control unit 40.

The precursors 23, 24 are mixed upstream of the plasma gun 30 and are pumped 26 into the atomizing nozzle 28, which feeds the resultant liquid particles into the region directly in front of the gun head into the core of the plasma 32. The heat of the plasma further disperses and mixes the liquid precursor particles and causes them to react in a hot spray mix 34. By the time they reach the substrate 36 several milliseconds later, the particles will have fully reacted to form the desired compounds and will also be molten. The impact of the molten droplets on the substrate 36 is accompanied by rapid cooling and shrinkage of the splats 42 as seen in FIG. 2, which induces a residual stress into the coating. The stresses generated in coatings formed by SPPS tend to be lower than those formed by conventional powder spraying due to a smaller size of the splats 42. There is also more splat area in contact with adjacent splats for this reason. The solid lubricant 46 formed via the SPPS process will incorporate itself uniformly in the microscopic interstices 44 in the coating 38, and will enhance the abradability of the resultant coating.

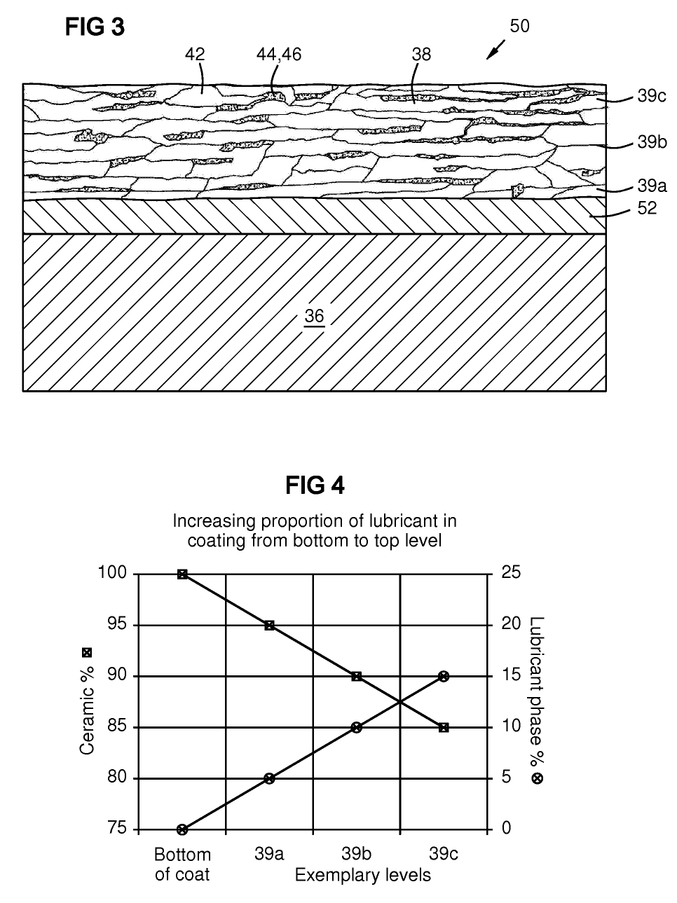

FIG. 2 illustrates layering 39a, 39b, 39c of splats 42. The geometry of FIG. 2 is simplified to illustrate the layering process, since the splats are generally not as uniform or symmetric as in FIG. 2. The substrate may be formed of a superalloy metal or a ceramic matrix composite material as known in the art. A bond coat 52 of a material such as CoNiCrAlY or NiCoCrAly may be applied to the substrate 36 prior to the TBC as known in the art. FIG. 3 shows a sectional geometry of the resulting coating 38 in a final coating system 50 on a substrate 36. Here again, FIG. 3 is simplified for illustration purposes and is not meant to be dimensionally accurate. The solid lubricant 46 is generally uniformly distributed per volume of the voids 44, and also is generally uniformly distributed per area of overlap in contact areas among the splats and between the lower splats and the bond coat 52. This uniformly reduces adherence of the splats in comparison to what it would be without the lubricant.

The solution constituents 22, 23, 24 are mixed in proportions that produce overlapping ceramic splats 42 that adhere to the substrate 36 or bond coat 52 and to each other to a desired degree. In other words, the solid lubricant is provided in an amount that produces desired amounts of both adhesion and abradability. If desired, the flow rate of the lubricant precursor 24 into the solution may be varied from a minimum, including none, to a maximum during the spraying process, so that lower levels or layers 39a of the coating 38 are adherent and stable, while higher levels or layers 39c are more abradable. This makes the higher levels preferentially abradable, and reduces the possibility of deeply chipping the coating during turbine operation. Thus, proportions of the lubricant phase in the coating may increase from a minimum or zero at a lower level 39a to a maximum at an upper level 39c. FIG. 4 shows an example of this in which 39a=5%, 39b=10%, and 39c=15% lubricant phase by volume.

The SPPS process is uniquely suited to form the desired coating structure due to its ability to produce fine, evenly sized splats, and the ability to incorporate solid lubricant precursors into the feedstock. Other solid lubricants such as MoS₂ can be formed similarly, by using suitable metal-organic precursors.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A process of producing an abradable thermal barrier coating, comprising:
mixing a liquid, a precursor of a ceramic material, and a precursor of a solid lubricant material together to form a solution; and
atomizing and heating the solution in a thermal spray directed toward a substrate to form the abradable thermal barrier coating on the substrate;
wherein the liquid, the ceramic precursor, and the solid lubricant precursor are mixed in proportions selected to produce overlapping ceramic splats adherent to the substrate and to each other, and to produce an amount of solid lubricant that is generally uniformly distributed between the splats and controls adherence of the splats, providing given degrees of both stability and abradability of the thermal barrier coating.

2. The process of claim 1, wherein the thermal spray is produced by injecting the solution into a plasma jet.

3. The process of claim 1, wherein the thermal spray is performed using spray parameters that produce layers of overlapping adherent splats of the ceramic material with the solid lubricant material generally uniformly distributed per void volume in interstices between the splats and generally uniformly distributed per area of overlap among the splats and between the splats and the substrate, whereby the solid lubricant material increases abradability of the thermal barrier coating.

4. The process of claim 3, wherein the ceramic precursor comprises yttria and zirconia, and the solid lubricant precursor comprises one or more of boron trichloride and urea, guanidine, or melamine.

5. The process of claim 4, wherein the resulting layers comprise yttria-stabilized zirconia splats, and hexagonal boron nitride is generally uniformly distributed as the solid lubricant among the splats.

6. The process of claim 1, wherein the mixing step comprises introducing the solid lubricant precursor into the solution at a flow rate that varies from a minimum or zero to a maximum during the spraying process, wherein lower layers of the coating are more adherent than higher layers, and the higher layers of the coating are more abradable than the lower layers.

7. The process of claim 6, wherein the minimum flow rate produces approximately 0.0-5.0 vol. % of the solid lubricant in a lower layer of the coating and the maximum flow rate produces approximately 15 vol. % of the solid lubricant in a higher layer of the coating.

8. The process of claim 6, wherein a CoNiCrAlY or NiCoCrAlY bond coat is applied to the substrate prior to the thermal barrier coating.

9. A process of producing an abradable thermal barrier coating comprising atomizing a precursor solution of a solid lubricant and a ceramic in a thermal spray and directing the thermal spray toward a substrate to form the abradable thermal barrier coating on the substrate.

10. The process of claim 8, wherein a solid lubricant precursor is introduced into the precursor solution at a rate that varies from a minimum or zero to a maximum during the spray process, producing proportions of the solid lubricant in the coating that vary from a minimum proportion or zero in a lower level of the coating to a maximum proportion in higher level of the coating.

11. The process of claim 10, wherein the minimum proportion is approximately 0.0-5.0 vol. % of the coating and the maximum proportion is approximately 15 vol. % of the coating.
